(19) United States
(12) Patent Application Publication
(10) Pub. No.: US 2013/0121216 A1
(43) Pub. Date: May 16, 2013

(54) METHOD AND APPARATUS FOR SOFT BUFFER MANAGEMENT FOR HARQ OPERATION

(71) Applicant: QUALCOMM INCORPORATED, San Diego, CA (US)

(72) Inventors: Wanshi Chen, San Diego, CA (US); Peter Gaal, San Diego, CA (US); Jelena Damnjanovic, Del Mar, CA (US); Juan Montojo, Nuremberg (DE)

(73) Assignee: QUALCOMM INCORPORATED, San Diego, CA (US)

(21) Appl. No.: 13/670,977

(22) Filed: Nov. 7, 2012

Related U.S. Application Data
(60) Provisional application No. 61/558,795, filed on Nov. 11, 2011.

(51) Int. Cl. H04W 72/04; H04J 3/00

(52) U.S. Cl. 370/280; 370/329

(57) ABSTRACT

Certain aspects of the present disclosure propose a method and an apparatus for calculating maximum number of hybrid automatic repeat request (HARQ) processes per component carrier and/or number of soft buffer bits for HARQ operation by taking into account the subframes which are available for a physical downlink shared channel (PDSCH) for a user equipment (UE) or a group of UEs. In the proposed method, the subframes that are not available for a PDSCH for at least a UE (either by specification or by configuration) may not be considered in calculating the number of soft buffer bits.

### CLAIM OF PRIORITY UNDER 35 U.S.C. §119

The present Application for Patent claims priority to U.S. Provisional Application No. 61/558,795, entitled, “Method and Apparatus for Soft Buffer Management for HARQ Operation,” filed Nov. 11, 2011, and assigned to the assignee hereof, which is hereby expressly incorporated by reference herein.

### TECHNICAL FIELD

Certain embodiments of the present disclosure generally relate to wireless communications and, more particularly, to managing soft buffers in hybrid automatic repeat request (HARQ) operation.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input-single-output, multiple-input-single-output or a multiple-input-multiple-output (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system may support time division duplex (TDD) and/or frequency division duplex (FDD) systems. In a TDD system, the forward and reverse link transmissions are on the same frequency region so that the reciprocity principle allows the estimation of the forward link channel from the reverse link channel. This enables the base station to extract transmit beamforming gain on the forward link when multiple antennas are available at the base station. In an FDD system, forward and reverse link transmissions are on different frequency regions.

### SUMMARY

Certain aspects of the present disclosure provide a method for wireless communications. The method generally includes determining, for each component carrier, a number of downlink subframes available for a physical downlink shared channel (PDSCH), and determining at least one of a maximum number of downlink hybrid automatic repeat request (HARQ) processes or a size of a soft buffer based at least on the number of downlink subframes available for PDSCH, wherein the downlink subframes unavailable for a PDSCH are not considered.

Certain aspects of the present disclosure provide an apparatus for wireless communications. The apparatus generally includes means for determining, for each component carrier, a number of downlink subframes available for a physical downlink shared channel (PDSCH), and means for determining at least one of a maximum number of downlink hybrid automatic repeat request (HARQ) processes or a size of a soft buffer based at least on the number of downlink subframes available for PDSCH, wherein the downlink subframes unavailable for a PDSCH are not considered.

Certain aspects provide a computer-program product for wireless communications, comprising a non-transitory computer-readable medium having instructions stored thereon, the instructions being executable by one or more processors. The instructions generally include instructions for determining, for each component carrier, a number of downlink subframes available for a physical downlink shared channel (PDSCH), and instructions for determining at least one of a maximum number of downlink hybrid automatic repeat request (HARQ) processes or a size of a soft buffer based at least on the number of downlink subframes available for PDSCH, wherein the downlink subframes unavailable for a PDSCH are not considered.

Certain aspects of the present disclosure provide an apparatus for wireless communications. The apparatus generally includes at least one processor and a memory coupled to the at least one processor. The processor is configured to determine, for each component carrier, a number of downlink subframes available for a physical downlink shared channel (PDSCH), and determine at least one of a maximum number of downlink hybrid automatic repeat request (HARQ) processes or a size of a soft buffer based at least on the number of downlink subframes available for PDSCH, wherein the downlink subframes unavailable for a PDSCH are not considered.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system, in accordance with certain embodiments of the present disclosure.

FIG. 2 illustrates a block diagram of a communication system, in accordance with certain embodiments of the present disclosure.

FIG. 3 is a block diagram conceptually illustrating an example of a frame structure in a wireless communications network in accordance with certain aspects of the present disclosure.

FIG. 4 illustrates a table including different user equipment (UE) categories and their corresponding parameters, as described in the long term evolution (LTE) standard.

FIG. 5 illustrates a table containing maximum number of downlink (DL) hybrid automatic repeat request (HARQ) processes for each time division duplex (TDD) uplink (UL)/DL configuration as described in Release-10 of the LTE standard.

FIG. 6 illustrates example operations that may be performed by a user equipment or a base station for soft buffer management in hybrid automatic repeat request (HARQ) operation, in accordance with certain aspects of the present disclosure.

FIG. 7 illustrates an example table showing the benefits of the proposed soft buffer management, in accordance with certain aspects of the present disclosure.

FIG. 8 illustrates an example network comprising a base station and a user equipment, in accordance with certain aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident; however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA 2000, etc. UTRA includes Wideband-CDMA (W-CDMA). CDMA2000 covers IS-2000, IS-95 and IS-856 standards. A TDMA network may implement a radio technology such as Global System for Mobile Communications (GSM).

An OFDMA network may implement a radio technology such as Evolved UTRA (E-UTRA), The Institute of Electrical and Electronics Engineers (IEEE) 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a recent release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various applications involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ratio (PAPR) because of its inherent single carrier structure. SC-FDMA may be used in the uplink communications where lower PAPR greatly benefits the mobile terminal in terms of transmit power efficiency. SC-FDMA is currently a working assumption for uplink multiple access scheme in 3GPP Long Term Evolution (LTE), or Evolved UTRA.

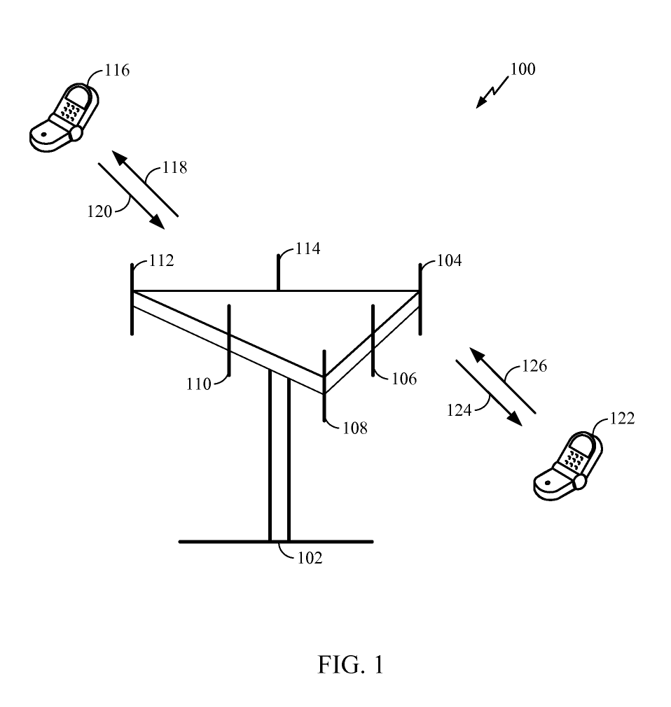

Referring to FIG. 1, a multiple access wireless communication system 100 according to one aspect is illustrated. An access point 102 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 118 and receive information from access terminal 116 over reverse link 120. Access terminal 122 is in communication with antennas 104 and 106, where antennas 104 and 106 transmit information to access terminal 122 over forward link 124 and receive information from access terminal 122 over reverse link 126. In a Frequency Division Duplex (FDD) system, communication links 118, 120, 124 and 126 may use a different frequency for communication. For example, forward link 118 may use a different frequency than that used by reverse link 120.

Each group of antennas and/or the area in which they are designed to communicate is often referred to as a sector of the access point. In an aspect, antenna groups each are designed to communicate to access terminals in a sector of the areas covered by access point 102.

In communication over forward links 118 and 124, the transmitting antennas of access point 102 utilize beamforming in order to improve the signal-to-noise ratio of forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal, or some other terminology. For certain aspects, either the AP 102 or the access terminals 116, 122 may utilize an interference cancellation technique as described herein to improve performance of the system.

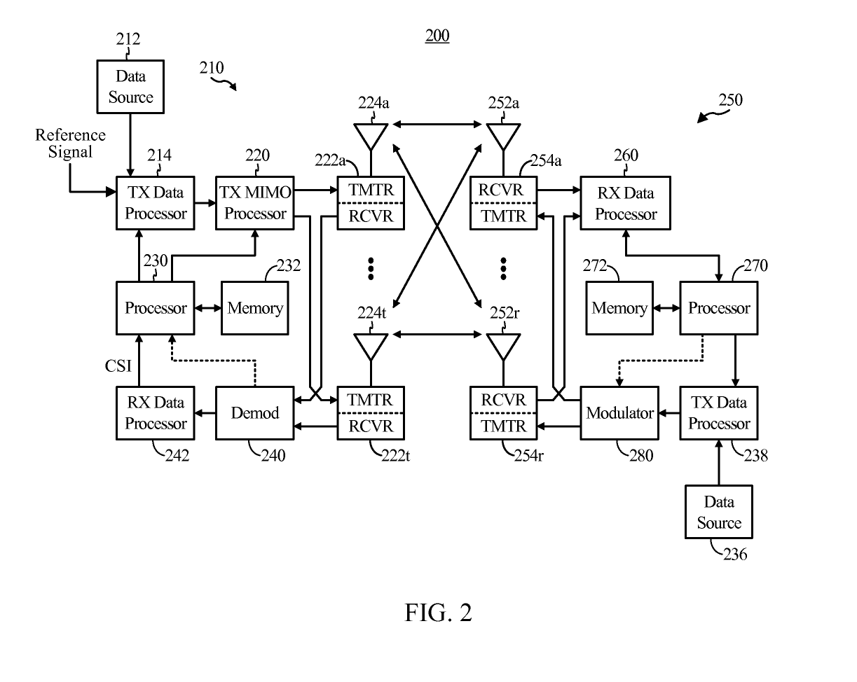

FIG. 2 is a block diagram of an aspect of a transmitter system 210 and a receiver system 250 in a MIMO system 200. At the transmitter system 210, traffic data for a number of data streams is provided from a data source 212 to a transmit (TX) data processor 214. An embodiment of the present disclosure is also applicable to a wireline (wired) equivalent system of FIG. 2

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., Binary Phase Shift Keying (BPSK), Quadrature Phase Shift Keying (QPSK), M-PSK in which M may be a power of two, or M-QAM (Quadrature Amplitude Modulation)) selected for that data stream to provide modulation symbols. The data rate, coding and modulation for each data stream may be determined by instructions performed by processor 230 that may be coupled with a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves and decodes each detected symbol stream to recover the traffic data for the data stream. The processing by RX data processor 260 is complementary to that performed by TX MIMO processor 220 and TX data processor 214 at transmitter system 210. As described in further detail below, the RX data processor 260 may utilize interference cancellation to cancel the interference on the received signal.

Processor 270, coupled to a memory 272, formulates a reverse link message. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve link message transmitted by the receiver system 250.

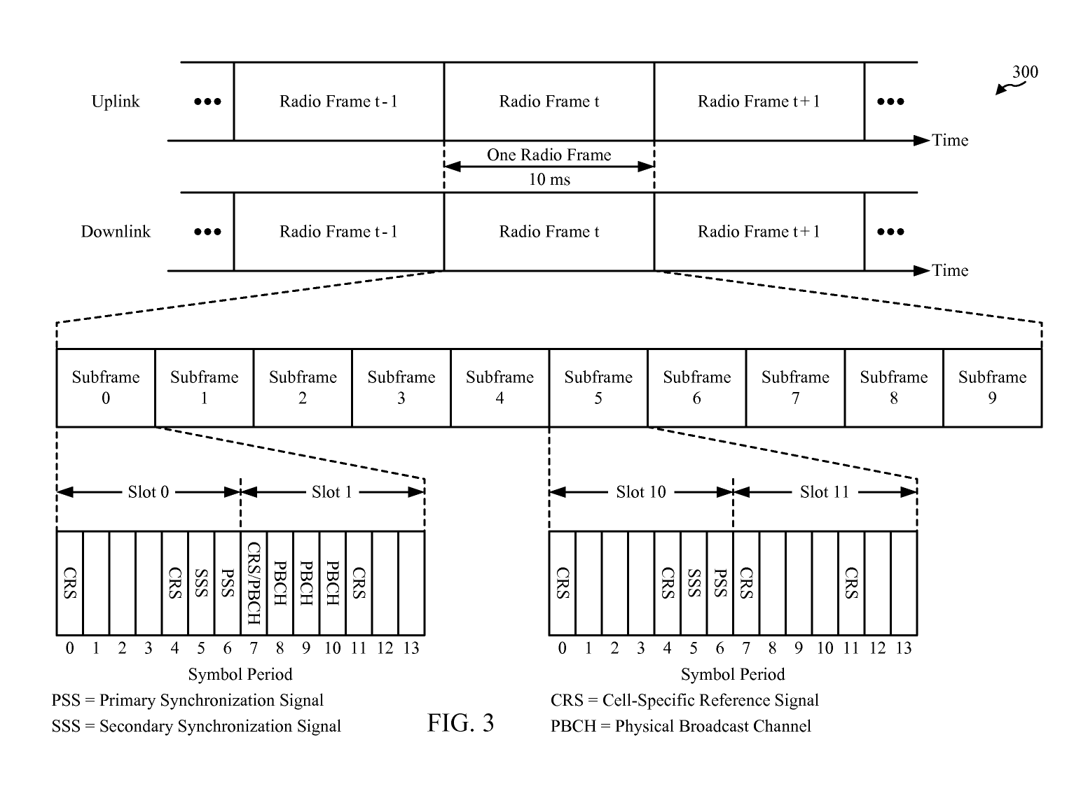

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 3) or six symbol periods for an extended cyclic prefix. The 2L symbol periods in each subframe may be assigned indices of 0 through 2L-1.

In LTE, an eNB may transmit a primary synchronization signal (PSS) and a secondary synchronization signal (SSS) on the downlink (e.g., in the center 1.08 MHz of the system bandwidth) for each cell supported by the eNB. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. The eNB may also transmit a cell-specific reference signal (CRS) across the system bandwidth for each cell supported by the eNB. The CRS is also known as a common reference signal. The CRS may be transmitted in certain symbol periods of each subframe and may be used by the UEs to perform channel estimation, channel quality measurement, and/or other functions. The eNB may also transmit a Physical Broadcast Channel (PBCH) in symbol periods 0 to 3 in slot 1 of certain radio frames. The PBCH may carry some system information. The eNB may transmit other system information such as System Information Blocks (SIBs) on a Physical Downlink Shared Channel (PDSCH) in certain subframes. The eNB may transmit control information/data on a Physical Downlink Control Channel (PDCCH) in the first B symbol periods of a subframe, where B may be configurable for each subframe. The eNB may transmit traffic data and/or other data on the PDSCH in the remaining symbol periods of each subframe.

The wireless network may support hybrid automatic retransmission (HARQ) for data transmission on the downlink and uplink. For HARQ, a transmitter (e.g., an eNB) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

### An Example Soft Buffer Management for HARQ Operation

In wireless communication systems, the data associated with one or more received messages may be stored in soft buffer memory. The soft buffer memory stores soft information associated with received bits, which are also referred to as soft bits. The soft information for a received bit may contain information about the most likely value of the bit and a measure of its reliability. The term “soft information” or “soft bit” generally refers to not making a hard decision about the value of a bit during demodulation and/or input to a decoder. These measures of reliability can be used in special soft decision decoders (e.g., Turbo decoders) to enhance decoding performance. For example, a decoded received packet and its supporting data (e.g., soft bits) are generally stored in soft buffer memory to accommodate combining the data with retransmitted data in the event that a determination is made that the packet was received in error for a previous transmission or previous retransmission. In a hybrid automatic retransmit request (HARQ) scheme, the receiver may request retransmission of a packet (or part of the packet), if the packet is not received correctly. At the receiver, the retransmitted packet may be combined with the originally received packet before decoding.

In 3GPP LTE, a receive buffer size may vary depending on capability of the UE. This is to limit the receive buffer size according to the UE capability since the increase in the receive buffer size may result in the increase in manufacturing costs of the UE. In particular, the maximum number of HARQ processes in asynchronous HARQ is important due to limited soft buffer capability of a UE. This is because the limited soft buffer size may result in the decrease in an available buffer size per HARQ process along with the increase in the maximum number of HARQ processes, and as a result, channel coding performance may decrease.

Certain aspects of the present disclosure propose a method and an apparatus for calculating maximum number of downlink hybrid automatic repeat request (HARQ) processes and/or size of a soft buffer by only taking into account the subframes which are available for PDSCH for a UE or a group of UEs. In the proposed method, the subframes that are not available for PDSCH for at least a UE (either by specification or by configuration) may not be considered in calculating the size of the soft buffer (in bits) and/or maximum number of downlink HARQ processes.

According to Release-10 of the long term evolution (LTE) standard, a user equipment (UE) may be configured with two or more component carriers (CCs). For example, the UE may be configured with one downlink (DL) CC and one uplink (UL) component carrier. Soft buffers may be used in base stations and user equipments. The soft buffers may be managed based on number of configured CCs, category and capabilities of the UE, maximum number of hybrid automatic repeat request (HARQ) processes, number of transport blocks, number of coded blocks, and other parameters.

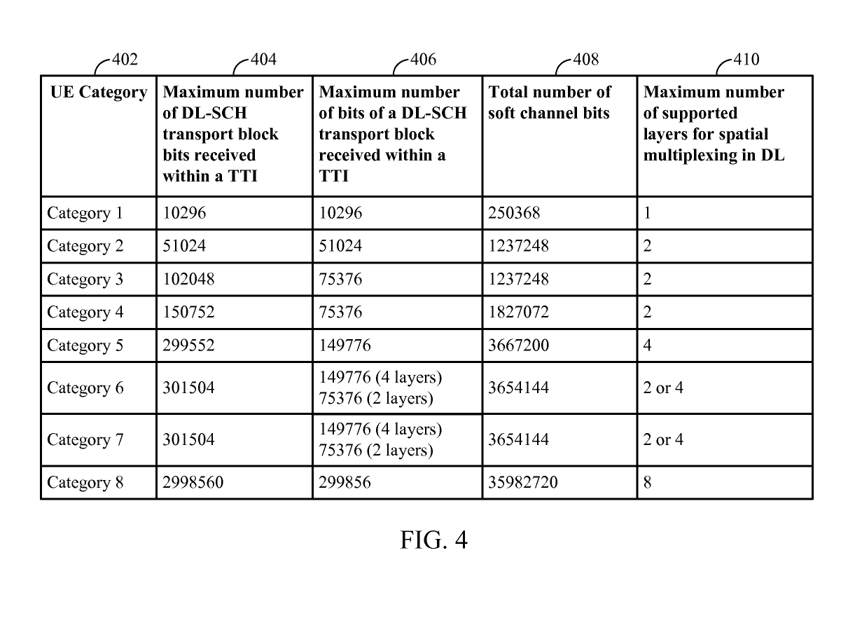

FIG. 4 illustrates a table including different UE categories and their corresponding parameters, as described in the LTE Rel-10 standard. A total of eight UE categories may be defined as shown in the table. The table illustrates parameters such as maximum number of DL-shared channel (SCH) transport block bits received within a transmission time interval (TTI) 404, maximum number of bits of a DL-SCH transport block received within a TTI 406, total number of soft channel bits 408, and maximum number of supported layers for spatial multiplexing in DL 410.

In FIG. 4, the field ‘UE Category’ 402 defines a combined uplink and downlink capability. The field ‘maximum number of DL-SCH transport block bits received within a TTI’ 404 defines the maximum number of DLSCH transport blocks bits that the UE is capable of receiving within a DLSCH TTI. This number does not include the bits of a DLSCH transport block carrying broadcast control channel (BCCH) in the same subframe. The field ‘maximum number of bits of a DLSCH transport block received within a TTI’ 406 defines the maximum number of DLSCH transport block bits that the UE is capable of receiving in a single transport block within a DLSCH TTI. The field ‘total number of DLSCH soft channel bits’ 408 defines the total number of soft channel bits available for HARQ processing. This number does not include the soft channel bits required by the dedicated broadcast HARQ process for the decoding of system information. The field ‘maximum number of supported layers for spatial multiplexing in DL’ 410 defines the maximum number of supported layers for spatial multiplexing per UE. The UE shall support the number of layers according to its Rel-8/9 category (Cat. 1-5) in all non-carrier aggregation band combinations.

For soft buffer management, the eNB may perform rate matching assuming for each component carrier, number of incremental redundancy operations (N_{IR}) may be calculated as follows:

$${N}_{IR} = ⌊ \frac{{N}_{soft}}{{K}_{C} \cdot {K}_{MIMO} \cdot min ( {M}_{DL\_HARQ} , {M}_{limit} )} ⌋ \qquad Eqn ( 1 )$$

in which N_{soft} may represent the total number of soft channel bits based on the UE category, as shown in column 408 of the table in FIG. 4. If N_{soft}=35982720, then K_{C} may be equal to five. Otherwise, if N_{soft}=3654144 and the UE is capable of supporting no more than a maximum of two spatial layers for the downlink (DL) cell, K_{C} may be equal to two. If none of the above conditions holds, K_{C} may be equal to one. K_{MIMO} may be equal to two if the UE is configured to receive physical downlink shared channel (PDSCH) transmissions based on transmission modes 3, 4, 8 or 9 (on a given CC). Otherwise, K_{MIMO} may be equal to one. M_{DL}_{_{—}}_{HARQ} may represent maximum number of DL hybrid automatic repeat request (HARQ) processes (on a given CC). Mₗᵢₘᵢₜ may be a constant, for example, equal to 8.

The UE may also determine number of soft channel bits and store these bits for HARQ operation. For both frequency division duplex (FDD) and time division duplex (TDD), if the UE is configured with more than one serving cell, for each serving cell and for at least K_{MIMO}·min(M_{DL}_{_{—}}_{HARQ}, Mₗᵢₘᵢₜ) transport blocks, upon decoding failure of a code block of a transport block, the UE may store received soft channel bits corresponding to a range of subframes, for example, at least wₖ, Wₖ₊₁, . . . , w_{mod(k+n}_{_{SB}}_{-1,N}_{_{cb}}₎, as follows:

$${n}_{SB} = min ( {N}_{cb} , ⌊ \frac{{N}_{soft}^{′}}{C \cdot {N}_{cells}^{DL} \cdot {K}_{MIMO} \cdot min ( {M}_{DL\_HARQ} , {M}_{limit} )} ⌋ ) , \qquad Eqn ( 2 )$$

where wₖ may correspond to virtual circular buffer bits, C may represent the number of coded blocks, M_{DL}_{_{—}}_{HARQ} may represent the maximum number of DL HARQ processes, D_{cells}^{DL} may represent number of configured serving cells, N′_{soft} may represent total number of soft channel bits according to the UE category. In determining k, the UE may give priority to storing soft channel bits corresponding to lower values of k. wₖ may correspond to a received soft channel bit. The range wₖ, wₖ₊₁, . . . , w_{mod(k+n}_{_{SB}}_{-1,N}_{_{cb}}) may include subsets not containing received soft channel bits.

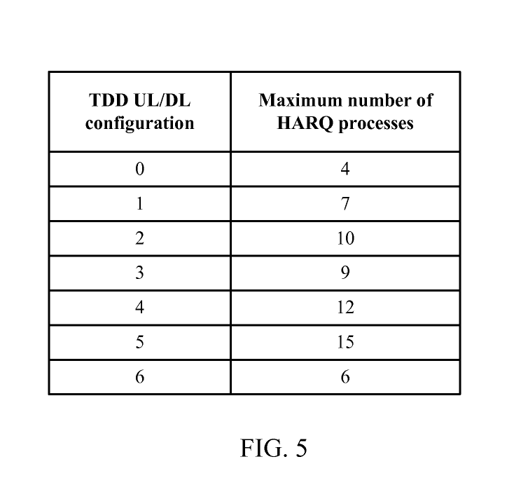

According to the Rel-10 of the LTE standard, maximum number of DL HARQ processes may be defined as follows: For FDD, there may be a maximum of eight downlink HARQ processes per serving cell. For TDD, the maximum number of downlink HARQ processes per serving cell may be determined by the UL/DL configuration, as indicated in the table illustrated in FIG. 5.

FIG. 5 illustrates a table containing maximum number of DL HARQ processes for each TDD UL/DL configuration as described in Rel-10 of the LTE standard. As shown, different UL/DL configurations may support different number of DL HARQ processes. For example, the TDD UL/DL configuration 0 may support up to four DL HARQ processes, whereas TDD UL/DL configuration 5 may support up to fifteen DL HARQ processes.

The maximum number of DL HARQ processes for FDD and TDD as defined in the LTE standard are determined based on the assumption that all downlink subframes available for PDSCH transmissions for a UE. However, in reality, a subframe may not be available for any PDSCH for a UE or a group of UEs (e.g., either by specification or by configuration). For example, in TDD, there may not be a PDSCH transmission in DwPTS (downlink pilot time slot) of special subframes in configurations 0 and 5 with normal downlink cyclic prefix (CP), or configurations 0 and 4 with extended downlink CP. Therefore, by specification, some or all of the UEs may not have PDSCH transmission in the special subframes.

As another example, Rel-8 and/or Rel-9 UEs may not have any PDSCH transmissions in multimedia broadcast/multicast services over a single frequency network (MBSFN) subframes. However, Rel-10 UEs may have PDSCH transmissions in the MBSFN subframes. In addition, a UE may be indicated not to monitor some subframes for PDSCH, e.g., almost blank subframes (ABS). Or, a UE may be configured not to monitor a set of subframes for any PDSCH transmission. For certain aspects, each UE may be configured differently or, a group of UEs may be configured to use or not use a set of subframes for PDSCH transmissions.

For certain aspects, when some subframes are unavailable for PDSCH for a UE (regardless of the reason), the maximum number of DL HARQ processes may effectively be reduced. Therefore, the maximum number of DL HARQ processes may be smaller than what is currently specified by the standard. For certain aspects, for soft buffer management at both the eNB and the UE sides, a smaller maximum number of DL HARQ processes may imply a larger soft buffer size (e.g., that may be used for rate matching) for each HARQ process, which may improve DL throughput. The positive impact may be more evident when the UE is configured with two or more component carriers. If the UE is configured with two or more CCs, the total soft channel bits may be split (e.g., either evenly or unevenly) across all the configured CCs. Therefore, size of the soft buffer may become relatively small for each CC.

Certain aspects of the present disclosure propose a method for calculating number of soft buffer bits for hybrid automatic repeat request (HARQ) operation by only taking into account the subframes which are available for PDSCH for a UE or a group of UEs. In the proposed method, the subframes that are unavailable for PDSCH for at least a UE (e.g., either by specification or by configuration) may not be considered in calculating the number of soft buffer bits.

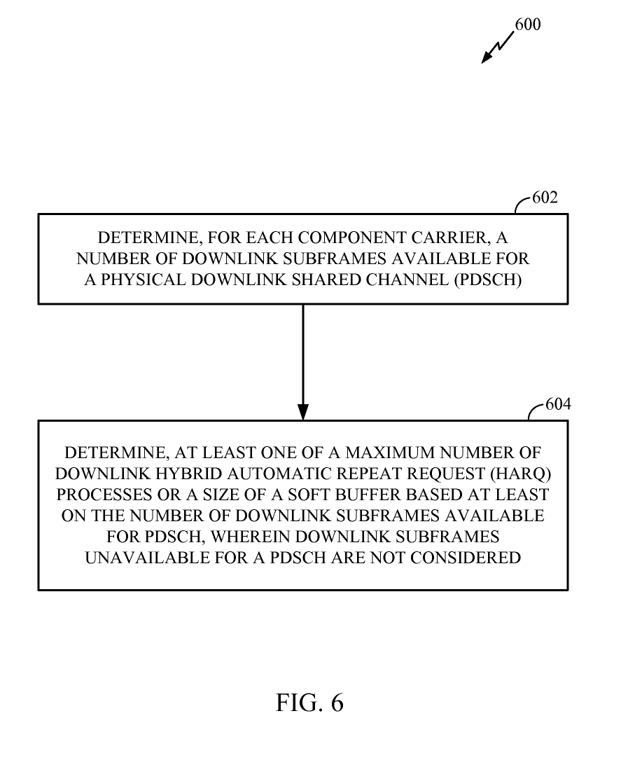

FIG. 6 illustrates example operations that may be performed by a UE or a base station for soft buffer management in HARQ operation. The operations may begin at 602 by determining for each component carrier, number of downlink subframes available for a physical downlink shared channel (PDSCH). At 604, the UE or the BS may then determine at least one of a maximum number of downlink hybrid automatic repeat request (HARQ) processes or size of a soft buffer based at least on the number of downlink subframes available for PDSCH. For certain aspects, the subframes that are unavailable for a PDSCH may not be considered in determining the maximum number of downlink HARQ processes or size of the soft buffer. For certain aspects, size of the soft buffer may be different for different component carriers.

For certain aspects, the subframes unavailable for PDSCH may be special subframes that are configured not to transmit any PDSCH in TDD mode. For certain aspects, number of subframes available for (or not available) PDSCH may be the same for a plurality of user equipments. For another aspect, the number of subframes available for (or not available for) PDSCH may be different for different UEs. For example, number of downlink subframes available for PDSCH may be determined for a first UE and a second UE. The number of subframes available for PDSCH may be specific to each of the first and the second UEs (e.g., UE-specific). For example, a downlink subframe may be available for a PDSCH for a first UE, but, the same subframe may not be available for a PDSCH for a second UE.

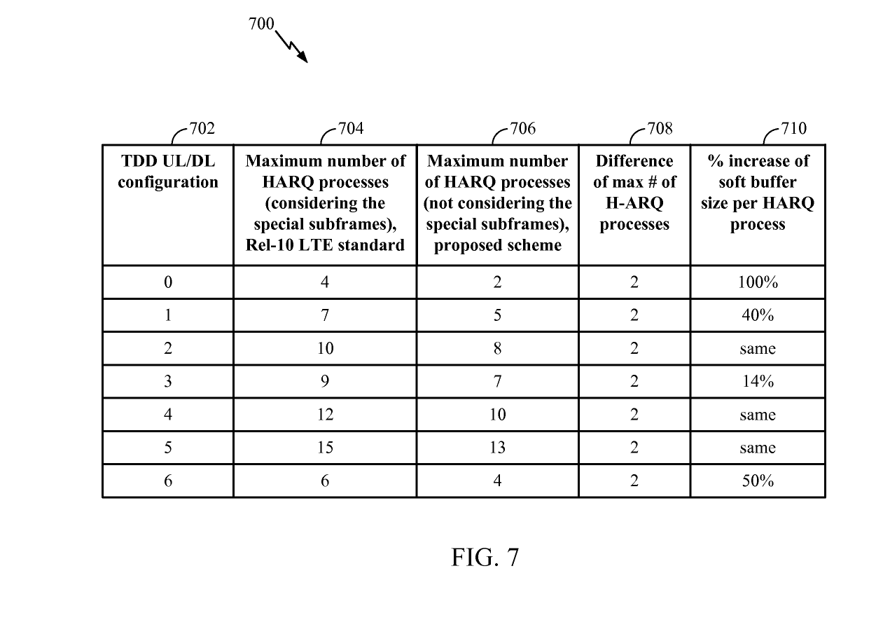

As an example, there may not be any PDSCH transmission in DwPTS of a special subframe (e.g., for special subframe configurations 0 and 5 with normal downlink CP, or configurations 0 and 4 with extended downlink CP). Therefore, based on the proposed method, the maximum number of DL H-ARQ processes may be calculated as shown in the table in FIG. 7.

FIG. 7 illustrates an example table showing the benefits of the proposed soft buffer management, in accordance with certain aspects of the present disclosure. The table illustrates TDD UL/DL configuration 702, maximum number of HARQ processes 704 (considering the special subframes as defined in Rel-10 of the LTE standard), maximum number of HARQ processes 706 (without considering the special subframes, the proposed scheme), difference of max number of HARQ processes 708 in the proposed scheme and the default scheme, and percentage of increase in soft buffer size per HARQ process 710 in the proposed scheme.

This table shows a maximum number of DL HARQ processes calculated with and without considering special subframes (e.g., configurations 0 and 5 with normal downlink CP or configurations 0 and 4 with extended downlink CP), and/or the subframes unavailable for a PDSCH for a UE. For example, column 706 shows maximum number of DL HARQ processes without considering special subframes (according to the proposed scheme). To enable comparisons, special subframes are taken into account during calculation of the maximum number of DL HARQ processes (as defined in the LTE standard) shown in column 704.

As can be seen in the example in FIG. 7, when the special subframes which by configuration are unavailable for PDSCH for any UE are not considered for calculating the maximum number of HARQ processes, the maximum number of HARQ processes may be reduced (e.g., by 2) for all the TDD downlink/uplink configurations. Reduction in the maximum number of HARQ processes may result in an increase in the number of soft buffer bits available for each DL HARQ process. For example, for the UL/DL configuration 0, the maximum number of HARQ processes in the proposed method is equal to two (column 706). Whereas, in the LTE standard (column 704), the maximum number of HARQ processes is equal to four. As a result, the total number of available soft buffer bits for the UE may be divided between two HARQ processes for the proposed method. The same number of available soft buffer bits may be divided among four HARQ processes, according to the LTE standard. Therefore, in this example, the proposed scheme may result in 100 percent increase in the number of soft buffer bits available for each HARQ process. As another example, for UL/DL configuration 3, the proposed scheme may result in 14 percent increase in the number of available soft buffer bits for each HARQ process. It should be noted that for configurations 2, 4 and 5, there is no increase in size of the soft buffer per each HARQ process (due to the Mₗᵢₘᵢₜ/operation in equations 1 and 2). However, as described earlier, for other configurations the number of soft buffer bits for each HARQ process may increase (e.g., between 14 to 100 percent).

As described earlier, for certain aspects, while managing soft buffers, maximum number of DL HARQ processes may be determined without considering some subframes which, by specification or by configuration, are not available for any PDSCH for a UE or a group of UEs. One particular example may be special subframes, which by configuration are not available for any PDSCH for the UEs.

For certain aspects, maximum number of DL HARQ processes may be calculated for each component carrier if there are two or more CCs that are configured for a UE. For example, in Rel-10 TDD, different CCs may have different configurations of special subframes (e.g., some CCs may have special subframes configured as unavailable for any PDSCH, while some may have special subframes configured as available for PDSCH). Therefore, different component carriers may have similar or different maximum number of DL HARQ processes, depending on their specific configuration.

As another example, in future generations of wireless systems, different CCs may have different TDD downlink/uplink configurations, different system types (e.g., FDD, TDD, and the like) or different configurations of MBSFN subframes, and the like. Therefore, as described herein, different number of HARQ processes may be calculated for different component carriers in which some of the subframes may or may not be considered in calculating the maximum number of HARQ processes for each component carrier.

For certain aspects, in order to maintain backward compatibility (e.g., maintain compliance with previous releases (e.g., Releases 8-10) of the LTE standard), it may be desirable to keep a conventional soft buffer management for at least one fully backward-compatible serving cell. Therefore, at least one communication link may be maintained between the eNB and the UE to ensure robust operation. For certain aspects, the proposed soft buffer management scheme may be activated only when the UE is configured with two or more cells. For example, the primary cell may be fully backward compatible and the proposed scheme may be applied to secondary cells. As an example, a UE may be configured to communicate via two or more component carriers (e.g., a primary component carrier and one or more secondary component carriers). Therefore, size of the soft buffer may be determined for the secondary component carriers based on the proposed method. For another aspect, the proposed soft buffer management scheme may be enabled only for extension carriers (e.g., carriers that are not backward compatible). However, it should be noted that such limitations are not preferable.

In this disclosure, a soft buffer management scheme is proposed in which during calculation of the maximum number of HARQ processes (and hence size of soft buffers) the subframes available for PDSCH may be considered. Therefore, the subframes that are not available for a PDSCH (e.g., either by specification or by configuration) may not be considered. The proposed soft buffer management scheme may result in increased soft buffer size per HARQ process, which may improve performance of the HARQ process.

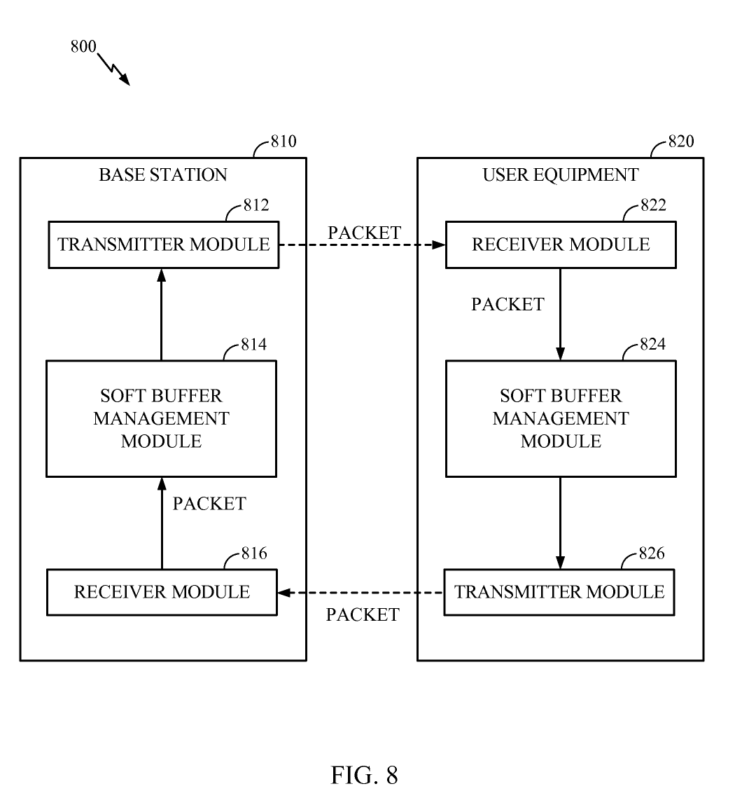

FIG. 8 illustrates an example network 800 comprising a base station and a user equipment, in which the proposed method may be utilized. The base station 810 may receive signals from the UE 820 and/or other base stations in its vicinity (not shown) using receiver unit 816. The base station may process the received signals using the soft buffer management module 814. In addition, the base station may determine maximum number of HARQ processes and/or size of a soft buffer based at least on the number of subframes available for PUSCH. For certain aspects, the subframes that are not available for a PUSCH may not be considered. The base station may then transmit a signal using the transmitter module 812 and communicate with the UE on one or more component carriers using HARQ operations. The UE 820 may receive a signal from the base station using the receiver module 822. Similar to the BS, the UE may determine, using the soft buffer management module 824, maximum number of downlink HARQ processes and/or size of a soft buffer for the UE based at least on the number of subframes available for PDSCH. For certain aspects, the subframes that are not available for a PDSCH may not be considered. The UE may then transmit signals to the BS 810 using the transmitter module 826 and perform HARQ operations with the BS, using the soft buffers.

It should be noted that although most of the examples in this disclosure refer to downlink HARQ operation and soft buffer management at the UE, similar ideas may be applied to other types of wired or wireless devices (e.g., base stations) for managing buffers, all of which would fall within the scope of the present disclosure.

The various operations corresponding to blocks illustrated in the method of FIG. 6 described above may be performed by various hardware and/or software component(s) and/or module(s). For example, means for determining may be any suitable processing component, such as a processor 230 and/or processor 270, as shown in FIG. 2.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for wireless communications, comprising:
determining, for each component carrier, a number of downlink subframes available for a physical downlink shared channel (PDSCH); and
determining at least one of a maximum number of downlink hybrid automatic repeat request (HARQ) processes or a size of a soft buffer based at least on the number of downlink subframes available for PDSCH, wherein the downlink subframes unavailable for a PDSCH are not considered.

2. The method of claim 1, wherein the downlink subframes unavailable for a PDSCH comprise one or more subframes unavailable for a PDSCH either by specification or by configuration.

3. The method of claim 2, wherein the downlink subframes unavailable for a PDSCH comprise special subframes that are configured not to transmit any PDSCH in time division duplex (TDD) mode.

4. The method of claim 2, wherein the downlink subframes unavailable for a PDSCH comprise multimedia broadcast over a single frequency network (MBSFN) subframes.

5. The method of claim 1, wherein the number of downlink subframes available for PDSCH is the same for a plurality of user equipments.

6. The method of claim 1, wherein the number of downlink subframes available for PDSCH is determined for a first user equipment (UE) and a second UE, wherein the number of subframes available for PDSCH is specific to each of the first and the second UEs.

7. The method of claim 6, wherein a downlink subframe is determined to be available for a PDSCH for the first UE, and is determined to be unavailable for a PDSCH for the second UE.

8. The method of claim 1, wherein a UE is configured to communicate via two or more component carriers comprising a primary component carrier and one or more secondary component carriers, wherein the size of the soft buffer is determined for the one or more secondary component carriers.

9. The method of claim 8, wherein the primary component carrier is in compliance with a first release of a standard and the secondary component carriers are in compliance with a second release of the standard later than the first release.

10. The method of claim 1, wherein the size of the soft buffer is determined for one or more extension carriers.

11. The method of claim 1, wherein the size of the soft buffer is different for different component carriers.

12. An apparatus for wireless communications, comprising:
means for determining, for each component carrier, a number of downlink subframes available for a physical downlink shared channel (PDSCH); and
means for determining at least one of a maximum number of downlink hybrid automatic repeat request (HARQ) processes or a size of a soft buffer based at least on the number of downlink subframes available for PDSCH, wherein the downlink subframes unavailable for a PDSCH are not considered.

13. The apparatus of claim 12, wherein the downlink subframes unavailable for a PDSCH comprise one or more subframes unavailable for a PDSCH either by specification or by configuration.

14. The apparatus of claim 13, wherein the downlink subframes unavailable for a PDSCH comprise special subframes that are configured not to transmit any PDSCH in time division duplex (TDD) mode.

15. The apparatus of claim 13, wherein the downlink subframes unavailable for a PDSCH comprise multimedia broadcast over a single frequency network (MBSFN) subframes.

16. The apparatus of claim 12, wherein the number of downlink subframes available for PDSCH is the same for a plurality of user equipments.

17. The apparatus of claim 12, wherein the number of downlink subframes available for PDSCH is determined for a first user equipment (UE) and a second UE, wherein the number of subframes available for PDSCH is specific to each of the first and the second UEs.

18. The apparatus of claim 17, wherein a downlink subframe is determined to be available for a PDSCH for the first UE, and is determined to be unavailable for a PDSCH for the second UE.

19. The apparatus of claim 12, wherein a UE is configured to communicate via two or more component carriers comprising a primary component carrier and one or more secondary component carriers, wherein the size of the soft buffer is determined for the one or more secondary component carriers.

20. The apparatus of claim 19, wherein the primary component carrier is in compliance with a first release of a standard and the secondary component carriers are in compliance with a second release of the standard later than the first release.

21. The apparatus of claim 12, wherein the size of the soft buffer is determined for one or more extension carriers.

22. The apparatus of claim 12, wherein the size of the soft buffer is different for different component carriers.

23. A computer-program product, comprising a non-transitory computer readable medium having instructions stored thereon, the instructions being executable by one or more processors and the instructions comprising:
instructions for determining, for each component carrier, a number of downlink subframes available for a physical downlink shared channel (PDSCH); and
instructions for determining at least one of a maximum number of downlink hybrid automatic repeat request (HARQ) processes or a size of a soft buffer based at least on the number of downlink subframes available for PDSCH, wherein the downlink subframes unavailable for a PDSCH are not considered.

24. An apparatus, comprising:
at least one processor configured to:
determine, for each component carrier, a number of downlink subframes available for a physical downlink shared channel (PDSCH), and
determine at least one of a maximum number of downlink hybrid automatic repeat request (HARQ) processes or a size of a soft buffer based at least on the number of downlink subframes available for PDSCH, wherein the downlink subframes unavailable for a PDSCH are not considered; and
a memory coupled to the at least one processor.
